(19) United States
(12) Patent Application Publication
(10) Pub. No.: US 2024/0396613 A1
(43) Pub. Date: Nov. 28, 2024

(54) TECHNIQUES FOR CROSS-FREQUENCY RANGE PREDICTIVE BEAM FAILURE DETECTION

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US); Yan ZHOU, San Diego, CA (US)

(21) Appl. No.: 18/714,795

(22) PCT Filed: Feb. 18, 2022
(86) PCT No.: PCT/CN2022/076731

§ 371 Date: May 30, 2024

(51) Int. Cl. H04B 7/06; H04B 17/318

(52) U.S. Cl. CPC H04B 7/06964; H04B 7/0626; H04B 17/328

(57) ABSTRACT

Various aspects of the present disclosure generally relate to wireless communication. In some aspects, a user equipment (UE) may receive a radio link monitoring configuration for a first serving cell that indicates a configuration of a first and second set of beam-failure-detection reference signals (BFD-RSs) associated with the first serving cell and a second serving cell, respectively. The UE may measure, in accordance with the radio link monitoring configuration, one or more BFD-RSs of the first set of BFD-RSs or the second set of BFD-RSs. The UE may determine a beam failure associated with at least one of the first serving cell or the second serving cell based at least in part on measuring the one or more BFD-RSs of the first set of BFD-RSs or the second set of BFD-RSs, respectively. Numerous other aspects are described.

### FIELD OF THE DISCLOSURE

Aspects of the present disclosure generally relate to wireless communication and to techniques and apparatuses for cross-frequency range predictive beam failure detection.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a radio link monitoring configuration for a first serving cell, wherein the radio link monitoring configuration indicates a configuration of a first set of beam-failure-detection reference signals (BFD-RSs) associated with the first serving cell, a configuration of a second set of BFD-RSs associated with a second serving cell, and a second serving cell identifier of the second serving cell. The method may include measuring, in accordance with the radio link monitoring configuration, at least one of one or more BFD-RSs of the first set of BFD-RSs, or one or more BFD-RSs of the second set of BFD-RSs. The method may include determining at least one of a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

Some aspects described herein relate to a method of wireless communication performed by a network entity. The method may include transmitting, to a UE, a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The method may include receiving, from the UE, a beam failure recovery request (BFRQ), wherein the BFRQ is based at least in part on a determination of at least one of a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

Some aspects described herein relate to an apparatus for wireless communication at a UE. The apparatus may include a memory and one or more processors coupled to the memory. The one or more processors may be configured to receive a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The one or more processors may be configured to measure, in accordance with the radio link monitoring configuration, at least one of one or more BFD-RSs of the first set of BFD-RSs, or one or more BFD-RSs of the second set of BFD-RSs. The one or more processors may be configured to determine at least one of a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

Some aspects described herein relate to an apparatus for wireless communication at a network entity. The apparatus may include a memory and one or more processors coupled to the memory. The one or more processors may be configured to transmit, to a UE, a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The one or more processors may be configured to receive, from the UE, a BFRQ, wherein the BFRQ is based at least in part on a determination of at least one of a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

Some aspects described herein relate to a non-transitory computer-readable medium that stores a set of instructions for wireless communication by a UE. The set of instructions, when executed by one or more processors of the UE, may cause the UE to receive a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The set of instructions, when executed by one or more processors of the UE, may cause the UE to measure, in accordance with the radio link monitoring configuration, at least one of one or more BFD-RSs of the first set of BFD-RSs, or one or more BFD-RSs of the second set of BFD-RSs. The set of instructions, when executed by one or more processors of the UE, may cause the UE to determine at least one of a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

Some aspects described herein relate to a non-transitory computer-readable medium that stores a set of instructions for wireless communication by a network entity. The set of instructions, when executed by one or more processors of the network entity, may cause the network entity to transmit, to a UE, a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The set of instructions, when executed by one or more processors of the network entity, may cause the network entity to receive, from the UE, a BFRQ, wherein the BFRQ is based at least in part on a determination of at least one of a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

Some aspects described herein relate to an apparatus for wireless communication. The apparatus may include means for receiving a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The apparatus may include means for measuring, in accordance with the radio link monitoring configuration, at least one of one or more BFD-RSs of the first set of BFD-RSs, or one or more BFD-RSs of the second set of BFD-RSs. The apparatus may include means for determining at least one of a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

Some aspects described herein relate to an apparatus for wireless communication. The apparatus may include means for transmitting, to a UE, a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The apparatus may include means for receiving, from the UE, a BFRQ, wherein the BFRQ is based at least in part on a determination of at least one of a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages are described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating examples of channel state information reference signal (CSI-RS) beam management procedures, in accordance with the present disclosure.

FIG. 6 is a diagram illustrating an example associated with cross-frequency range predictive beam failure detection, in accordance with the present disclosure.

FIG. 7 is a diagram illustrating an example associated with aperiodic CSI-RS (AP-CSI-RS) and/or semipersistent CSI-RS (SP-CSI-RS) resource scheduling for cross-frequency range predictive beam failure detection, in accordance with the present disclosure.

FIG. 8 is a diagram illustrating an example associated with AP-CSI-RS and/or SP-CSI-RS resource scheduling for cross-frequency range predictive beam failure detection, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

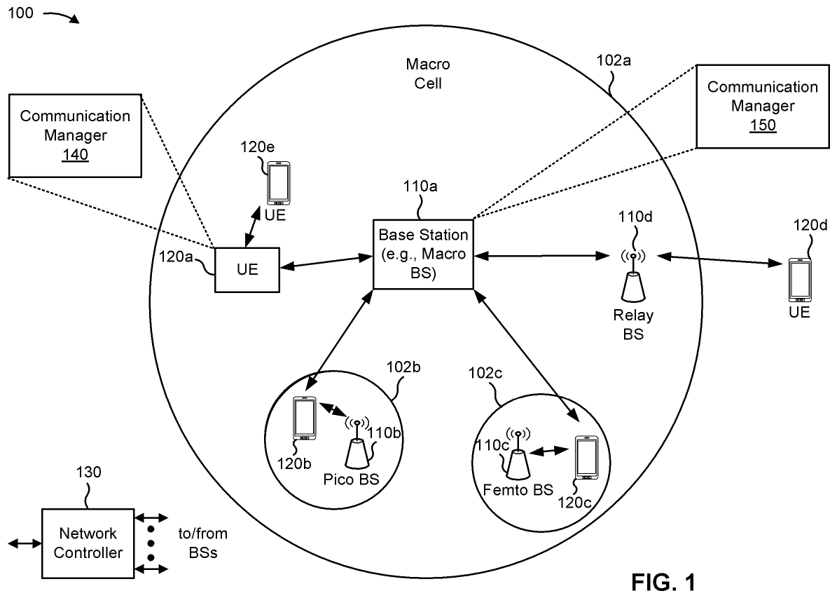

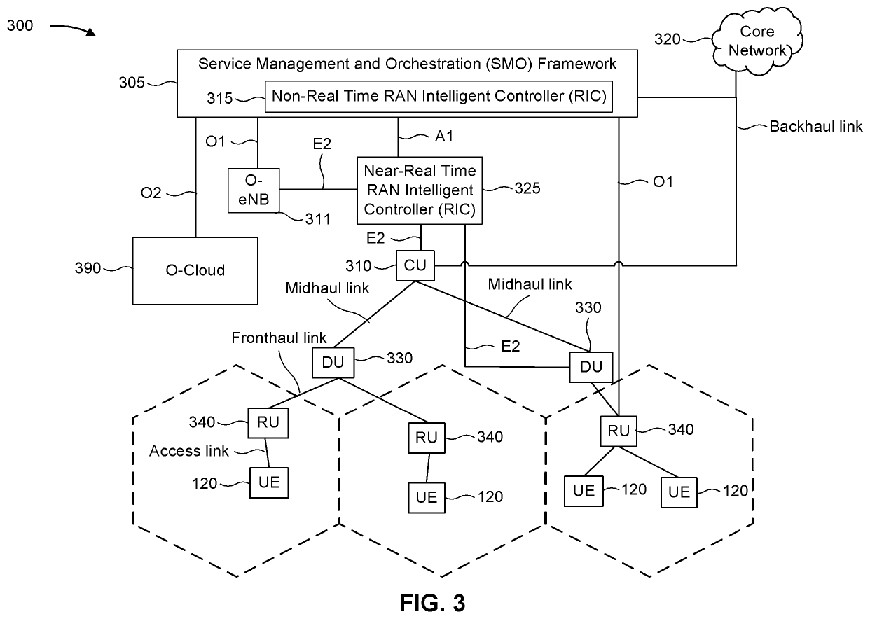

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a radio link monitoring configuration for a first serving cell, wherein the radio link monitoring configuration indicates: a configuration of a first set of beam-failure-detection reference signals (BFD-RSs) associated with the first serving cell, a configuration of a second set of BFD-RSs associated with a second serving cell, and a second serving cell identifier of the second serving cell: measure, in accordance with the radio link monitoring configuration, at least one of: one or more BFD-RSs of the first set of BFD-RSs, or one or more BFD-RSs of the second set of BFD-RSs; and determine at least one of: a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs. Additionally, or alternatively, the communication manager 140 may perform one or more other operations described herein.

In some aspects, the base station 110 may include a communication manager 150. As described in more detail elsewhere herein, the communication manager 150 may transmit, to a UE, a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell; and receive, from the UE, a beam failure recovery request (BFRQ), wherein the BFRQ is based at least in part on a determination of at least one of: a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs. Additionally, or alternatively, the communication manager 150 may perform one or more other operations described herein.

As indicated above, FIG. 1 is provided as an example. Other examples may differ from what is described with regard to FIG. 1.

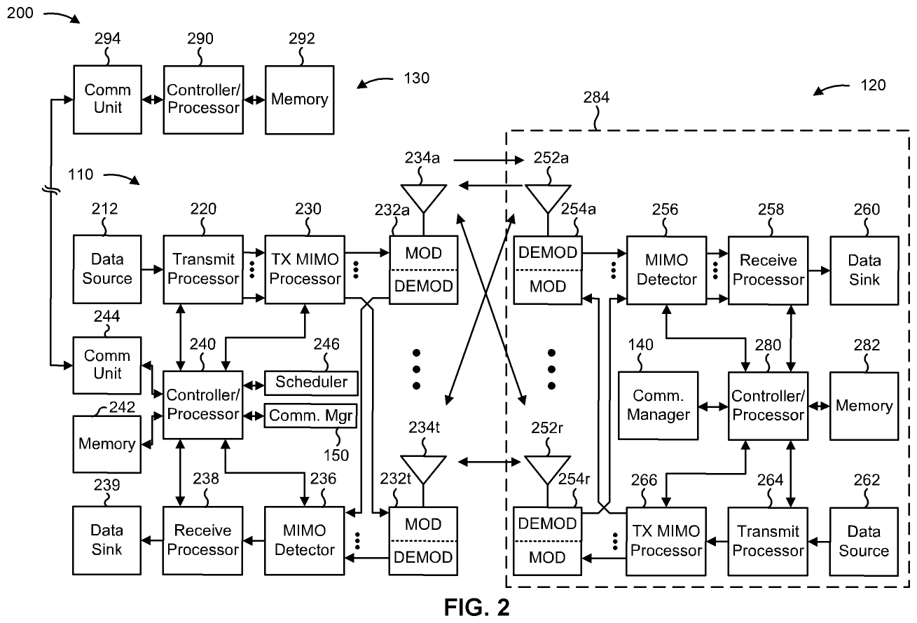

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

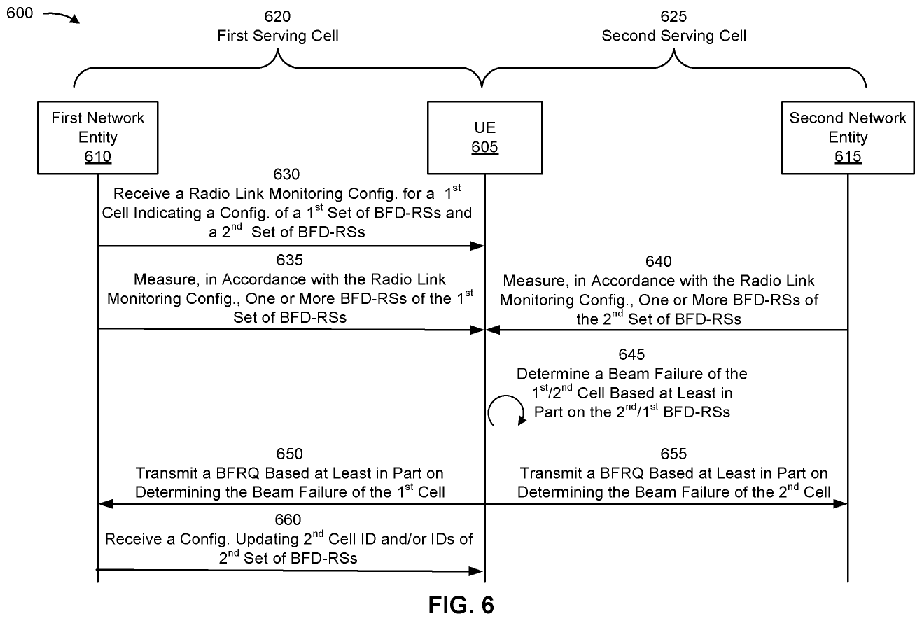

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

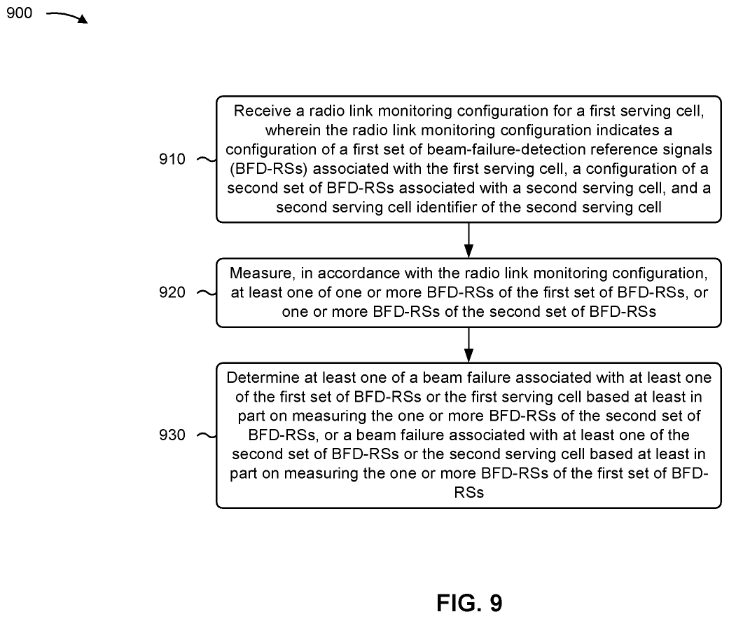

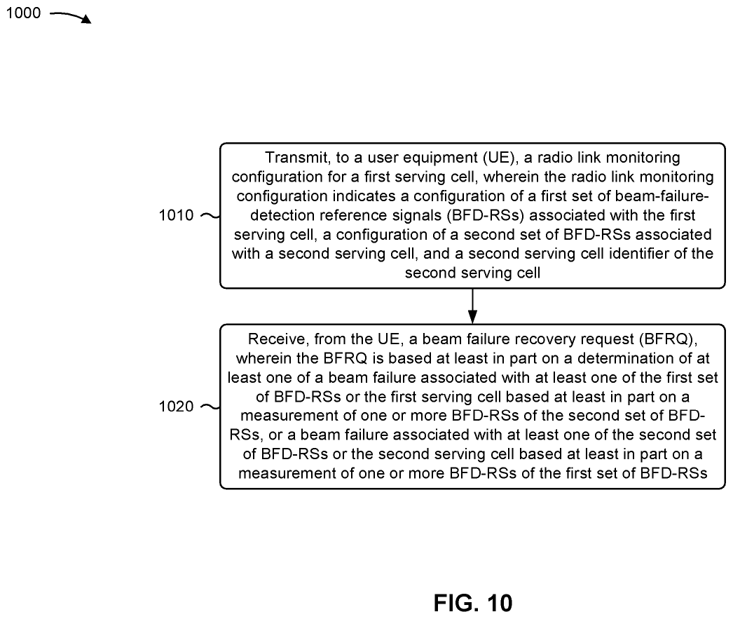

The controller/processor 240 of the base station 110, the controller/processor 280 of the UE 120, and/or any other component(s) of FIG. 2 may perform one or more techniques associated with cross-frequency range predictive beam failure detection, as described in more detail elsewhere herein. In some aspects, the network entity described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell: means for measuring, in accordance with the radio link monitoring configuration, at least one of: one or more BFD-RSs of the first set of BFD-RSs, or one or more BFD-RSs of the second set of BFD-RSs; and/or means for determining at least one of: a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell; and/or means for receiving, from the UE, a BFRQ, wherein the BFRQ is based at least in part on a determination of at least one of: a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

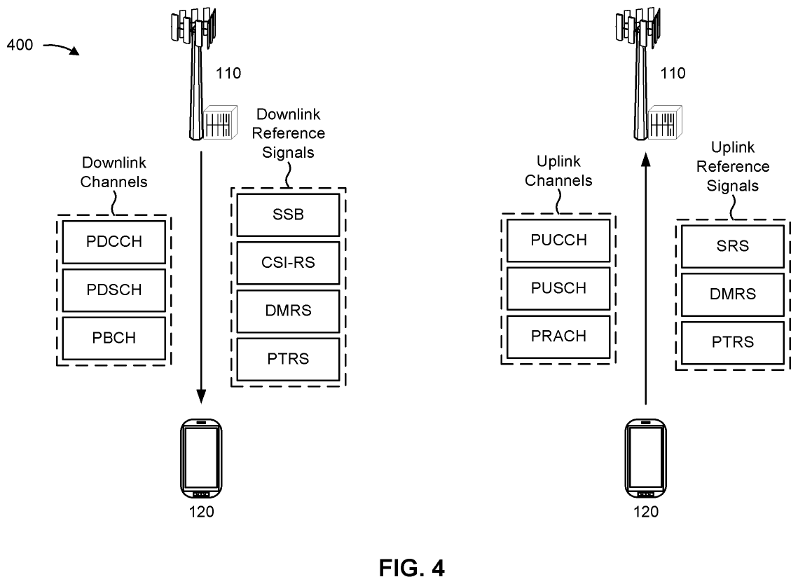

FIG. 4 is a diagram illustrating an example 400 of physical channels and reference signals in a wireless network, in accordance with the present disclosure. In some aspects, two or more of the network devices described above in connection with FIGS. 1-3 may exchange various reference signals for purposes of beam failure detection (BFD), among others. As shown in FIG. 4, downlink channels and downlink reference signals may carry information from a base station 110 or a similar network entity (e.g., a CU 310, a DU 330, an RU 340, or the like) to a UE 120, and uplink channels and uplink reference signals may carry information from a UE 120 to a base station 110 or a similar network entity.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

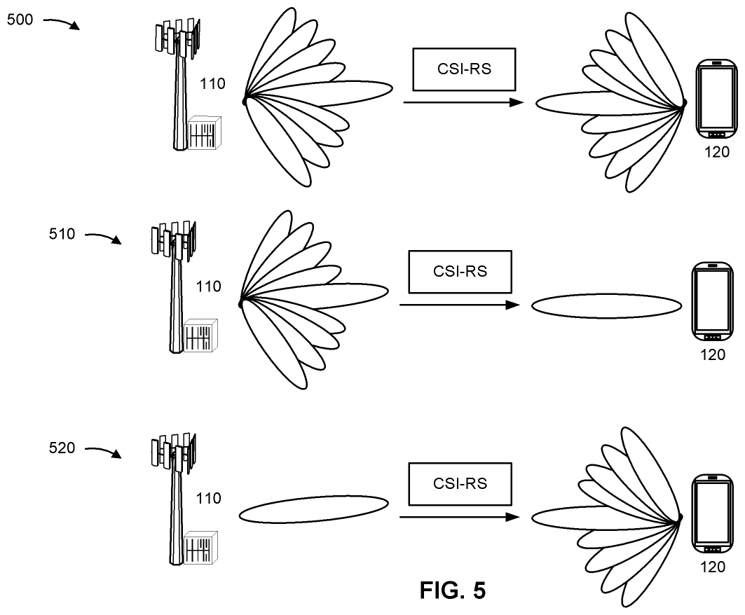

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 or a similar network entity may transmit multiple SSBs on multiple corresponding beams, and the SSBs may be used for beam selection, which is described more fully below in connection with FIG. 5.

A CSI-RS may carry information used for downlink channel estimation (e.g., downlink CSI acquisition), which may be used for scheduling, link adaptation, or beam management, among other examples. The base station 110 or a similar network entity may configure a set of CSI-RSs for the UE 120, and the UE 120 may measure the configured set of CSI-RSs. Based at least in part on the measurements, the UE 120 may perform channel estimation and may report channel estimation parameters to the base station 110 or a similar network entity (e.g., in a CSI report), such as a channel quality indicator (CQI), a precoding matrix indicator (PMI), a CSI-RS resource indicator (CRI), a layer indicator (LI), a rank indicator (RI), or a RSRP, among other examples. The base station 110 or a similar network entity may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 or a similar network entity to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 or a similar network entity may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 or a similar network entity may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 or a similar network entity may measure the SRSs, may perform channel estimation based at least in part on the measurements, and may use the SRS measurements to configure communications with the UE 120.

As described, one or more of the reference signals described above may be used for purposes of BFD. For example, SSBs and/or CSI-RSs may be used for purposes of BFD and thus may sometimes be referred to herein as BFD-RSs. Aspects of the BFD-RSs are described in more detail below in connection with FIG. 5.

As indicated above, FIG. 4 is provided as an example. Other examples may differ from what is described with regard to FIG. 4.

FIG. 5 is a diagram illustrating examples 500, 510, and 520 of CSI-RS beam management procedures, in accordance with the present disclosure. As shown in FIG. 5, examples 500, 510, and 520 include a UE 120 in communication with a base station 110 or a similar network entity (e.g., a CU 310, a DU 330, an RU 340, or the like) in a wireless network (e.g., wireless network 100). However, the devices shown in FIG. 5 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 5, example 500 may include a base station 110 and a UE 120 communicating to perform beam management using CSI-RSs. Example 500 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 5 and example 500, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 500 has been described in connection with CSI-RSs, the first beam management process may also use SSBs for beam management in a similar manner as described above.

As shown in FIG. 5, example 510 may include a base station 110 and a UE 120 communicating to perform beam management using CSI-RSs. Example 510 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 5 and example 510, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 5, example 520 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 5 and example 520, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

Other examples of beam management procedures may differ from what is described above. For example, the UE 120 and the base station 110 or a similar network entity may perform the third beam management procedure before performing the second beam management procedure, and/or the UE 120 and the base station 110 or a similar network entity may perform a similar beam management procedure to select a UE transmit beam.

Moreover, in some aspects, the UE 120 may determine a beam failure and thus initiate a beam recovery procedure in order to reestablish a transmit beam from the base station 110 or a similar network entity. That is, after a suitable transmit beam is determined, the UE 120 may monitor BFD-RSs to determine if a beam failure has occurred. As described above in connection with FIG. 4, in some aspects, one or more SSBs and/or CSI-RSs may be configured as BFD-RSs. More particularly, the base station 110 or a similar network entity may configure the BFD-RSs used for detecting beam failure in a specific bandwidth part (BWP) by a radio link monitoring configuration (sometimes referred to as radioLinkMonitoringConfig). In some aspects, the radio link monitoring configuration may indicate a set \tilde{q}₀ of periodic CSI-RS (P-CSI-RS) resource configuration indexes by a failure DetectionResourcesToAddModList parameter. The set \tilde{q}₀ of P-CSI-RS resource may include at most two periodic single-port CSI-RS or SSB resource indexes. If the failure DetectionResourcesToAddModList parameter is absent (e.g., if the UE 120 is not provided the \tilde{q}₀), the UE 120 may determine the set q, to include P-CSI-RS resource configuration indexes with same values as the reference signal indexes in the reference signal sets indicated by a parameter associated with the transmission configuration indicator (TCI) state (sometimes referred to as TCI-State) for respective control resource sets (CORESETs) that the UE uses for monitoring PDCCH. If there are two reference signal indexes in a TCI state, the set \tilde{q}₀ includes reference signal indexes configured with a quasi co-location (QCL) parameter (e.g., qcl-Type) set to a specific type (e.g., “typeD”). The UE 120 expects the set \tilde{q}₀ comprises at most two CSI-RS/SSB resources, and, if CSI-RS resources, the UE expects 120 only single port CSI-RS resources in set \tilde{q}₀.

Once configured with the BFD-RSs, the UE 120 may determine a beam failure and thus request a beam failure recovery procedure when a number of beam failure instances (BFIs) reaches a configured threshold. More particularly, the UE 120 may perform one or more measurements on a BFD-RS (such as an RSRP measurement) and may determine a BFI when the measurement is below a threshold value (e.g., 10% block error rate (BLER) of a hypothetical PDCCH, or the like). Once a threshold number of BFIs are detected, the UE 120 may determine a beam failure and initiate a recovery procedure, such as by sending the base station 110 or a similar network entity a beam failure recovery request (BFRQ) and/or by performing a random access procedure (e.g., a contention free random access (CFRA) procedure or a contention based random access (CBRA) procedure) on one or more beams.

However, for certain frequency ranges, monitoring BFD-RSs for purposes of determining a beam failure may require a large amount of signaling overhead and power consumption, and may be subject to certain scheduling restrictions. For example, when operating in relatively high frequencies, such as when operating in FR2 and/or millimeter-wave frequencies, beams may be relatively narrow in order to travel far enough distances to serve a UE 120. Thus, a single, narrow FR2 beam may only serve one UE 120 or else may serve a relatively low number of UEs. In contrast, for lower frequencies such as FR1 or the like, beams may be subject to less propagation loss and, accordingly, may be wider and/or serve more UEs 120. As a result, many more BFD-RSs may need to be signaled for FR2 beams and/or millimeter-wave beams than are necessary for FR1 beams and/or lower frequency ranges, increasing signaling overhead. Moreover, FR2 beams and/or other millimeter-wave beams may be swept in the time domain (e.g., may be time division multiplexed (TDMed)), thus introducing certain scheduling restrictions for transmitting BFD-RSs, which may not be present for frequency division multiplexed (FDMed) and/or code division multiplexed (CDMed) FR1 beams or the like. Similarly, measuring TDMed swept beams may require that a UE 120 alter its receive beams via phase shifting or the like to measure the BFD-RSs, which may consume more power than reception beamforming in FR1 or other frequency ranges. Accordingly, determining a beam failure in FR2 and/or other millimeter-wave frequencies may result in increased signaling overhead, increased power consumption, and reduced scheduling flexibility.

Some techniques and apparatuses described herein enable cross-frequency range beam failure detection. For example, in some aspects, a UE (e.g., the UE 120) may predict a beam failure in a first frequency range or serving cell (e.g., FR2) by measuring BFD-RSs in a second frequency range or serving cell (e.g., FR1). In some aspects, the UE may use a network configured machine learning model to predict the beam failure in the first frequency range based at least in part on the measurements in the second frequency range. For example, an input to the machine learning model may be an RSRP measurement of the BFD-RSs associated with the second frequency range, a PDCCH hypothesis BLER associated with the BFD-RSs of the second frequency range, a channel estimation associated with the BFD-RSs of the second frequency range, and/or a number of BFIs associated with the BFD-RSs of the second frequency range. In some aspects, the UE may transmit a BFRQ in the first frequency range or else initiate a beam recovery procedure based at least in part on the predicted beam failure in the first frequency range according to the beam measurements in the second frequency range. Because less signaling overhead is needed to signal BFD-RSs in FR1 or the like, because less power is required to measure such BFD-RSs, and because such BFD-RSs have more scheduling flexibility, measuring the BFD-RSs in the second frequency range for predicting beam failures in the first frequency range results in reduced signaling overhead, reduced power consumption, increased scheduling flexibility, and overall more efficient network usage.

As indicated above, FIG. 5 is provided as an example. Other examples may differ from what is described with regard to FIG. 5.

FIG. 6 is a diagram illustrating an example 600 associated with cross-frequency range predictive beam failure detection, in accordance with the present disclosure. As shown in FIG. 6, a UE 605 (e.g., the UE 120) may communicate with a first network entity 610 (e.g., a base station 110, a CU 310, a DU 330, an RU 340, or the like) and a second network entity 615 (e.g., another base station 110, another CU 310, another DU 330, another RU 340, or the like). Moreover, as described above, the UE 605, the first network entity 610, and the second network entity 615 may communicate using multiple frequency ranges or serving cells. For example, the first network entity 610 may be associated with a first serving cell 620, and the second network entity 615 may be associated with a second serving cell 625 different from the first serving cell 620. In some aspects, the first serving cell 620 corresponds to one of FR1 or FR2, and the second serving cell 625 corresponds to the other of FR1 or FR2.

As shown by reference number 630, the UE 605 may receive, from the first network entity 610, a radio link monitoring configuration (e.g., radioLinkMonitoringConfig) in the first serving cell 620. The radio link monitoring configuration may indicate a configuration of a first set of BFD-RSs associated with the first serving cell 620, a configuration of a second set of BFD-RSs associated with a second serving cell 625, and a second serving cell identifier of the second serving cell 625. More particularly, the radio link monitoring configuration may indicate a set of resources (e.g., time and/or frequency resources) associated with the first set of BFD-RSs for the first serving cell 620, which may be resources associated with SSBs and/or CSI-RSs in the first serving cell 620. Similarly, the radio link monitoring configuration may indicate a set of resources (e.g., time and/or frequency resources) associated with the second set of BFD-RSs for the second serving cell 625, which may be resources associated with SSBs and/or CSI-RSs in the second serving cell 625. The radio link monitoring configuration may also include the second serving cell identifier and/or may further include an indication associating the second set of BFD-RSs with the second serving cell 625 and/or the second serving cell identifier. For example, the radio link monitoring configuration (e.g., radioLinkMonitoringConfig) may indicate a list of resources associated with the second set of BFD-RSs (sometimes referred to as failure DetectionResourcesToAddModList-Fy), which, in some aspects, may be associated with the second serving cell identifier. In some aspects, the radio link monitoring configuration may be received via an RRC message or the like.

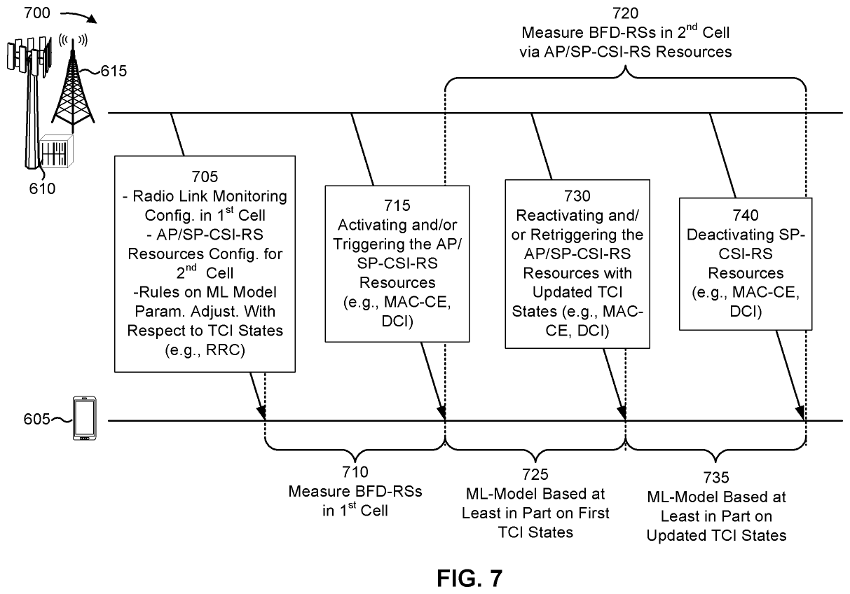

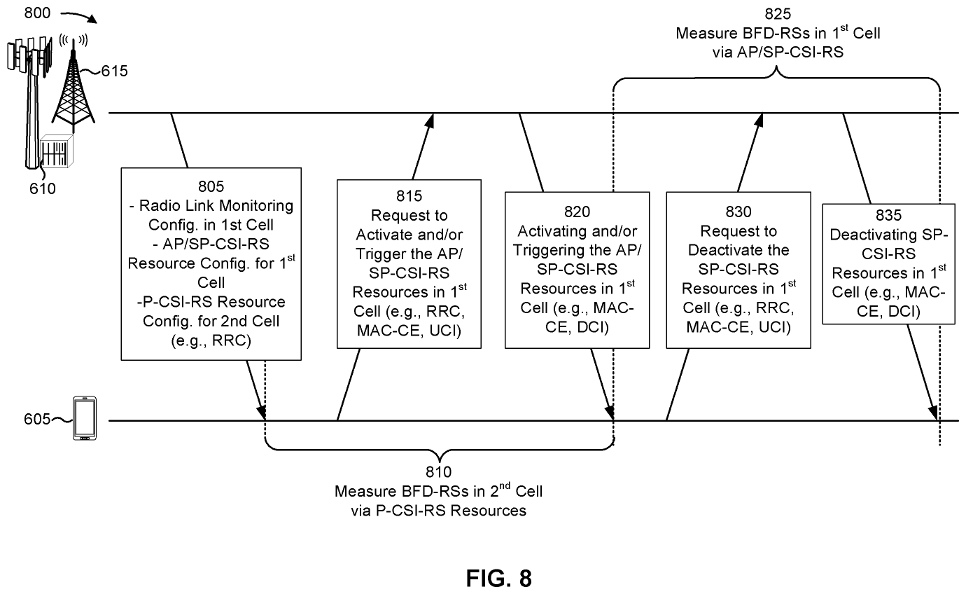

In some aspects, the first set of BFD-RSs or the second set of BFD-RSs may be associated with multi-port CSI-RS resources. Accordingly, in such aspects, the UE 605 may be further configured with parameters enabling the multi-port CSI-RS features (e.g., the UE 605 may receive, via the RRC message or the like, a configuration of the multi-port CSI-RS resources). Moreover, in some aspects, the first set of BFD-RSs or the second set of BFD-RSs may be associated with one of aperiodic CSI-RS (AP-CSI-RS) resources or semipersistent CSI-RS (SP-CSI-RS) resources. In such aspects, the UE 605 may receive additional configurations of the AP-CSI-RS and/or the SP-CSI-RS resources and/or one or more additional messages triggering, activating, reactivating, and/or deactivating the AP-CSI-RS and/or the SP-CSI-RS resources. Aspects of BFD-RSs associated with the AP-CSI-RS and/or the SP-CSI-RS resources are described in more detail below in connection with FIGS. 7 and 8.

As shown by reference numbers 635 and 640, the UE 605 may measure one or more BFD-RSs in accordance with the radio link monitoring configuration. For example, in some aspects, the UE 605 may measure, in accordance with the radio link monitoring configuration, one or more BFD-RSs of the first set of BFD-RSs, as shown by reference number 635. Additionally, or alternatively, the UE 605 may measure, in accordance with the radio link monitoring configuration, one or more BFD-RSs of the second set of BFD-RSs, as shown by reference number 640. Moreover, in aspects in which the BFD-RSs of the first set of BFD-RSs and/or the second set of BFD-RSs are associated with multi-port CSI-RS resources, the measurement of the one or more BFD-RSs of the first set of BFD-RSs (as shown by reference number 635) or the one or more BFD-RSs of the second set of BFD-RSs (as shown by reference number 640) may include performing measurements associated with each port of the multi-port CSI-RS resources. For example, in such aspects, the UE 605 may perform an RSRP measurement associated with each port of the multi-port CSI-RS resources and/or may estimate a channel associated with the multi-port CSI-RS resources. Moreover, in aspects in which at least some of the BFD-RSs are associated with AP-CSI-RS and/or the SP-CSI-RS resources, the UE 605 may perform measurements on the corresponding BFD-RSs when the AP-CSI-RS and/or the SP-CSI-RS resources are triggered and/or activated, which is described in more detail in connection with FIGS. 7 and 8.

In some aspects, one or more of the measurements described in connection with reference numbers 635 and 640 may be performed in a dormant BWP of one of the serving cells. For example, in addition to the first serving cell 620 and the second serving cell 625, the UE 605 may be in wireless communication with a third serving cell. Moreover, a BWP associated with an active BWP identifier in the second serving cell may be a dormant BWP conditioned on a second frequency range associated with the second serving cell 625 being higher than a third frequency range associated with the third serving cell and lower than a first frequency range associated with the first serving cell 620. In such aspects, the UE 605 may measure the one or more BFD-RSs of the second set of BFD-RSs in the dormant BWP.

For example, in some aspects, the UE 605 may be operating in a dual connectivity mode or the like, and thus the UE 605 may be in wireless communication with multiple cells including the first serving cell 620, the second serving cell 625, and the third serving cell. Moreover, the third serving cell may be associated with a first RAT (e.g., a 4G RAT) and/or may be associated with a first cell group (e.g., a master cell group (MCG)). In some aspects, the third serving cell may the special cell (SpCell) of the MCG. Moreover, the first serving cell 620 and the second serving cell 625 may be associated with a second RAT (e.g., 5G NR) and/or may be associated with a second cell group (e.g., a secondary cell group (SCG)). Furthermore, the third serving cell may be associated with FR1, the first serving cell 620 may be associated with FR2, and the second serving cell may be associated with FR3. In this case, the frequency range associated with the second serving cell 625 (e.g., FR3) is higher than a frequency range associated with the third serving cell (e.g., FR1) and is lower than a frequency range associated with the first serving cell 620 (e.g., FR2). Accordingly, in this case, the BWP identified by the active BWP identifier associated with the second serving cell 625 may be a dormant BWP, and/or the UE 605 may measure the one or more BFD-RSs of the second set of BFD-RSs in the dormant BWP.

As shown by reference number 645, the UE 605 may determine a beam failure associated with at least one of the first serving cell 620 or the second serving cell 625 based at least in part on measuring the second set of BFD-RSs or the first set of BFD-RSs, respectively. More particularly, in some aspects, the UE 605 may determine a beam failure associated with at least one of the first set of BFD-RSs or the first serving cell based at least in part on measuring the one or more BFD-RSs of the second set of BFD-RSs. In some other aspects, the UE 605 may determine a beam failure associated with at least one of the second set of BFD-RSs or the second serving cell based at least in part on measuring the one or more BFD-RSs of the first set of BFD-RSs. In this way, the UE 605 may perform cross-frequency range beam failure detection (e.g., may determine a beam failure in one serving cell by measuring BFD-RSs in another serving cell), which, as described above in connection with FIG. 5, may result in reduced signaling overhead, reduced power consumption, increased scheduling flexibility, and overall more efficient network usage.

In some aspects, the determination shown by reference number 645 may be based at least in part on one or more machine learning models. More particularly, in some aspects, the UE 605 may be configured, by one or more of the network entities 610, 615 and/or by another network entity, with a machine learning model. In some aspects, the UE 605 may receive a configuration of the machine learning model via the configuration shown at reference number 630, while, in some other aspects, the UE 605 may receive the configuration of the machine learning model via a different configuration and/or message from the network.

In aspects in which the machine learning model is used to determine a beam failure associated with the at least one of the first set of BFD-RSs or the first serving cell 620 (e.g., in aspects in which the output of the machine learning model is the beam failure associated with the first serving cell 620, a predicted number of BFIs associated with the first serving cell 620, or the like), an input to the machine learning model may be based at least in part on a measurement of one or more BFD-RSs of the second set of BFD-RSs (e.g., one or more BFD-RSs associated with the second serving cell 625). For example, in such aspects, an input to the machine learning model may be based at least in part on at least one of an RSRP measurement, a PDCCH hypothesis BLER, a channel estimation, or a number of BFIs associated with the one or more BFD-RSs of the second set of BFD-RSs. Similarly, in aspects in which the machine learning model is used to determine a beam failure associated with the at least one of the second set of BFD-RSs or the second serving cell 625 (e.g., in aspects in which the output of the machine learning model is the beam failure associated with the second serving cell 625, a predicted number of BFIs associated with the second serving cell 625, or the like), an input to the machine learning model may be based at least in part on a measurement of one or more BFD-RSs of the first set of BFD-RSs (e.g., one or more BFD-RSs associated with the first serving cell 620). For example, in such aspects, an input to the machine learning model may be based at least in part on at least one of an RSRP measurement, a PDCCH hypothesis BLER, a channel estimation, or a number of BFIs associated with the one or more BFD-RSs of the first set of BFD-RSs.

As shown by reference numbers 650 and 655, in some aspects, the UE 605 may initiate a beam failure recovery procedure based at least in part on the determination shown at reference number 645. For example, when the beam failure associated with the at least one of the first set of BFD-RSs or the first serving cell is determined based at least in part on measuring the one or more BFD-RSs of the second set of BFD-RSs, the UE 605 may transmit a BFRQ to the first network entity 610, as shown by reference number 650. Additionally, or alternatively, when the beam failure associated with the at least one of the second set of BFD-RSs or the second serving cell is determined based at least in part on measuring the one or more BFD-RSs of the first set of BFD-RSs, the UE 605 may transmit a BFRQ to the second network entity 615, as shown by reference number 655.

As shown by reference number 660, in some aspects the first network entity 610 may dynamically change and/or update parameters associated with the second serving cell 625, such as the second serving cell identifier. In some aspects, the network entity 610 may update such parameters when, in response to changing channel conditions or the like, the first network entity 610 determines that the UE 605 should measure BFD-RSs in a different second serving cell for purposes of determining a beam failure associated with at least one of the first set of BFD-RSs or the first serving cell 620. For example, the UE 605 may receive, from the first network entity 610, a configuration indicating an updated second serving cell identifier and/or indicating updated identifiers associated with the BFD-RSs of the second set of BFD-RSs. In some aspects, the configuration updating the second serving cell identifier and/or indicating updated identifiers associated with the BFD-RSs of the second set of BFD-RSs may be received via one of a MAC-CE message or a DCI message.

As indicated above, FIG. 6 is provided as an example. Other examples may differ from what is described with respect to FIG. 6.

FIG. 7 is a diagram illustrating an example 700 associated with AP-CSI-RS and/or SP-CSI-RS resource scheduling for cross-frequency range predictive beam failure detection, in accordance with the present disclosure.

As described above in connection with reference number 630, in some aspects the first set of BFD-RSs and/or the second set of BFD-RSs may be associated with at least one of AP-CSI-RS resources or SP-CSI-RS resources. For example, as shown by reference number 705, the UE 605 may receive, in the first serving cell 620, the radio link monitoring configuration (as described above in connection with reference number 630), which may include, or else be transmitted in addition to, an AP-CSI-RS resource configuration associated with the second serving cell 625 and/or an SP-CSI-RS resource configuration associated with the second serving cell 625. The UE 605 may additionally be configured with a machine learning model (as described above in connection with reference number 645), which may indicate certain rules regarding certain parameter adjustments with respect to different TCI states of the AP-CSI-RS and/or an SP-CSI-RS resources. In some aspects, the configurations shown by reference number 705 may be transmitted to the UE 605 via an RRC message.

When the second set of BFD-RSs are associated with the AP-CSI-RS and/or SP-CSI-RS resources, the UE 605 may not measure the BFD-RSs of the second set of BFD-RSs prior to the AP-CSI-RS and/or SP-CSI-RS resources being triggered and/or activated by an activation message associated with the one of the AP-CSI-RS resources or the SP-CSI-RS resources. For example, as shown by reference number 710, prior to the AP-CSI-RS and/or SP-CSI-RS resources being triggered and/or activated, the UE 605 may measure BFD-RSs of the first set of BFD-RSs for purposes of determining a beam failure associated with the first serving cell 620. Put another way, prior to the AP-CSI-RS and/or SP-CSI-RS resources being triggered and/or activated, the UE 605 may not perform cross-frequency range predictive beam failure detection, and instead the beam failure associated with the at least one of the first set of BFD-RS or the first serving cell 620 may be determined based at least in part on measuring one or more BFD-RSs of the first set of BFD-RSs.

As shown by reference number 715, the UE 605 may receive signaling (sometimes referred to an activation message) from one of the network entities (e.g., the first network entity 610) triggering and/or activating the AP-CSI-RS and/or the SP-CSI-RS resources. The activation message may be provided by one of a MAC-CE message or a DCI message. Accordingly, as shown by reference number 720, after receiving the activation message, the UE 605 may begin to measure BFD-RSs associated with the second serving cell 625. Put another way, based at least in part on receiving an activation message associated with the one of the AP-CSI-RS resources or the SP-CSI-RS resources (as shown by reference number 715), the UE 605 may measure the second set of BFD-RSs (as shown by reference number 720), and thus determine a beam failure associated with at least one of the first set of BFD-RSs or the first serving cell 620 based at least in part on measuring the one or more BFD-RSs of the second set of BFD-RSs, as described above in connection with reference number 645.

As shown by reference number 725, in aspects employing a machine learning model to determine a beam failure associated with at least one of the first set of BFD-RSs or the first serving cell 620 based at least in part on measuring the one or more BFD-RSs of the second set of BFD-RSs, the UE 605 may initially use machine learning model parameters and/or TCI states associated with the initial configuration received at reference number 705. However, in some aspects, the machine learning model parameters and/or TCI states may be dynamically changed via signaling associated with the AP-CSI-RS and/or SP-CSI-RS resources. For example, as shown by reference number 730, the UE 605 may receive signaling (sometimes referred to as a reactivation message) retriggering and/or reactivating the AP-CSI-RS resources and/or the SP-CSI-RS resources, and thus the UE 605 may continue to measure the second set of BFD-RSs accordingly, as shown by reference number 720. Moreover, the reactivation message may include additional and/or updated configurations and parameters for use in determining the beam failure. For example, the reactivation message may include updated TCI states for the AP-CSI-RS and/or SP-CSI-RS resources and/or updated parameters associated with the machine learning model. In some aspects, the configuration shown by reference number 705 may indicate machine learning parameters associated with each one of multiple TCI states. Thus, if the TCI state is updated using the reactivation message or the like, the UE 605 may accordingly use the parameters associated with the updated TCI state as indicated in the initial configuration message (e.g., the configuration message shown by reference number 705). As shown at reference number 735, the UE 605 may thus use the updated machine learning model parameters and/or TCI states associated with the reactivation message to determine a beam failure associated with at least one of the first set of BFD-RSs or the first serving cell based at least in part on measuring the one or more BFD-RSs of the second set of BFD-RSs.

For AP-CSI-RS resources, the resource configuration may expire absent a subsequent activation and/or reactivation message, at which point the UE 605 may revert to measuring BFD-RSs of the first set of BFD-RSs for purposes of determining a beam failure associated with the first serving cell 620. Put another way, activating or reactivating the AP-CSI-RS resources may start a configured timer, and, if the timer elapses prior to the UE 605 receiving an additional activation or reactivation message, the AP-CSI-RS resources may expire and the UE 605 may stop measuring the AP-CSI-RS resources. For SP-CSI-RS resources, the resource configuration may remain valid until the UE 605 receives signaling (sometimes referred to as a deactivation message) deactivating the SP-CSI-RS resources, as shown by reference number 740. The deactivation message may be transmitted via one of a MAC-CE message or a DCI message. Once the deactivation message is received by the UE 605, the UE 605 may revert to measuring BFD-RSs of the first set of BFD-RSs for purposes of determining a beam failure associated with the first serving cell 620.

Although in FIG. 7, for ease of description, the AP-CSI-RS and/or the SP-CSI-RS resources are described as being associated with the BFD-RSs of the second serving cell 625 and thus used to determine a beam failure associated with the first serving cell 620, aspects of the disclosure are not so limited. In some other aspects, the AP-CSI-RS and/or SP-CSI-RS resources may be associated with the BFD-RSs of the first serving cell 620, and thus the AP-CSI-RS and/or SP-CSI-RS resources may be utilized for determining a beam failure associated with the second serving cell 625 in a similar manner as described above, without departing from the scope of the disclosure.

As indicated above, FIG. 7 is provided as an example. Other examples may differ from what is described with respect to FIG. 7.

FIG. 8 is a diagram illustrating an example 800 associated with AP-CSI-RS and/or SP-CSI-RS resource scheduling for cross-frequency range predictive beam failure detection, in accordance with the present disclosure.

In some aspects, the UE 605 may request activation of BFD-RSs associated with one of the serving cells 620, 625, such as by requesting activation and/or triggering of the AP-CSI-RS and/or SP-CSI-RS resources associated with BFD-RSs. For example, as shown by reference number 805, the UE 605 may receive, in the first serving cell 620, the radio link monitoring configuration (as described above in connection with reference number 630), which may include, or else be transmitted in addition to, an AP-CSI-RS resource configuration associated with the first serving cell 620 and/or an SP-CSI-RS resource configuration associated with the first serving cell 620. The UE 605 may additionally be configured with P-CSI-RS resources associated with the second set of BFD-RSs (e.g., resources for measuring BFD-RSs in the second serving cell 625, as described in connection with reference number 640). In some aspects, the configurations shown by reference number 805 may be transmitted to the UE 605 via an RRC message.

In this case, prior to the AP-CSI-RS and/or the SP-CSI-RS resources being triggered (which, in this example, are associated with the BFD-RSs of the first serving cell 620), the UE 605 will measure BFD-RSs associated with the second serving cell 625. More particularly, as shown by reference number 810, the UE 605 may use the P-CSI-RS resources for measuring one or more BFD-RSs of the second set of BFD-RSs, and may accordingly determine a beam failure associated with at least one of the first set of BFD-RSs or the first serving cell 620 based at least in part on measuring the one or more BFD-RSs of the second set of BFD-RSs, as described above in connection with reference number 645. In this aspect, however, the UE 605 may request activation of the AP-CSI-RS and/or the SP-CSI-RS resources for purposes of conducting additional BFD-RS measurements or the like.

More particularly, as shown by reference number 815, the UE 605 may transmit to a network entity (e.g., the first network entity 610) a request to activate the AP-CSI-RS and/or the SP-CSI-RS resources, which, as described, are associated with the BFD-RSs of the first set of BFD-RSs in this example (e.g., the AP-CSI-RS and/or the SP-CSI-RS resources are associated with the first serving cell 620). In some aspects, the request shown at reference number 815 may be transmitted using an RRC message, a MAC-CE message, or a UCI message.

As shown at reference number 820, the UE 605 may receive signaling (e.g., an activation message) from one of the network entities (e.g., the first network entity 610) triggering and/or activating the AP-CSI-RS and/or the SP-CSI-RS resources associated with the first set of BFD-RSs (e.g., associated with the first serving cell 620). This signaling may be provided by one of a MAC-CE message or a DCI message. Accordingly, as shown by reference number 825, the UE 605 may begin to measure BFD-RSs associated with the first serving cell 620. Put another way, based at least in part on receiving an activation message associated with the AP-CSI-RS and/or the SP-CSI-RS resources (as shown by reference number 820), the UE 605 may measure the first set of BFD-RSs (as shown by reference number 825), and may determine the beam failure associated with at least one of the first set of BFD-RSs or the first serving cell 620 based at least in part on measuring the one or more BFD-RSs of the first set of BFD-RSs.

In some aspects, the UE 605 may transmit the request to activate the AP-CSI-RS resources and/or the SP-CSI-RS resources based at least in part on determining the beam failure associated with the at least one of the first set of BFD-RSs or the first serving cell by measuring the BFD-RSs of the second set of BFD-RSs. More particularly, the UE 605 may determine a beam failure in the first serving cell 620 by measuring the BFD-RSs in the second serving cell 625, as described in connection with reference number 645. The UE 605 may then request activation of the AP-CSI-RS and/or the SP-CSI-RS resources (as shown by reference number 815) to confirm the beam failure determined by the machine learning models or the like. More particularly, once activated, the UE 605 may measure the BFD-RSs in the first serving cell 620, and if such measurements confirm the beam failure determined by measuring the BFD-RSs in the second serving cell 625, the UE 605 may initiate the beam recovery procedure, as described in connection with reference number 650.

Additionally, or alternatively, the UE 605 may request activation of the AP-CSI-RS and/or the SP-CSI-RS resources based at least in part on certain measurements of the BFD-RSs meeting or falling below a threshold value or the like. For example, the UE 605 may request activation of the AP-CSI-RS and/or SP-CSI-RS resources based at least in part on an RSRP associated with one or more BFD-RSs of the second set BFD-RSs, or a PDCCH hypothesis BLER associated with one or more BFD-RSs of the second set of BFD-RSs. More particularly, if the RSRP associated with one or more BFD-RSs of the second set BFD-RSs falls below a threshold RSRP value, the UE 605 may request activation of the AP-CSI-RS and/or SP-CSI-RS resources. Additionally, or alternatively, if the PDCCH hypothesis BLER exceeds a threshold BLER (e.g., 10% or the like), the UE 605 may request activation of the AP-CSI-RS and/or SP-CSI-RS resources.

As described above in connection with FIG. 7, for AP-CSI-RS resources, activating or reactivating the AP-CSI-RS resources may start a configured timer, and, if the timer elapses prior to the UE 605 receiving an additional activation or reactivation message, the UE 605 may stop measuring the AP-CSI-RS resources. For SP-CSI-RS resources, the resource configuration may remain valid until the UE 605 receives signaling (sometimes referred to as a deactivation message) deactivating the SP-CSI-RS resources. In some aspects, the UE 605 may transmit a request for such a deactivation message, as shown by reference number 830, which may be transmitted using one of an RRC message, a MAC-CE message, or a UCI message. In response, the UE 605 may receive a message deactivating the SP-CSI-RS, as shown by reference number 835. In some aspects, the deactivation message may be transmitted using one of a MAC-CE message or a DCI message. Once the AP-CSI-RS and/or SP-CSI-RS resources expire and/or are deactivated, the UE 605 may return to monitoring only the BFD-RSs associated with the second set of BFD-RSs, until the AP-CSI-RS and/or SP-CSI-RS resources are reactivated (e.g., in response to an additional request from the UE 605, or otherwise).

Although in FIG. 8, for ease of description, the AP-CSI-RS and/or SP-CSI-RS resources are described as being associated with the BFD-RSs of the first serving cell 620 and are described as being used to determine a beam failure associated with the first serving cell 620, aspects of the disclosure are not so limited. In some other aspects, the AP-CSI-RS and/or SP-CSI-RS resources may be associated with the BFD-RSs of the second serving cell 625, and the AP-CSI-RS and/or SP-CSI-RS resources may be utilized for determining a beam failure associated with the second serving cell 625 in a similar manner as described above, without departing from the scope of the disclosure.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120, UE 605, or the like) performs operations associated with cross-frequency range predictive beam failure detection.

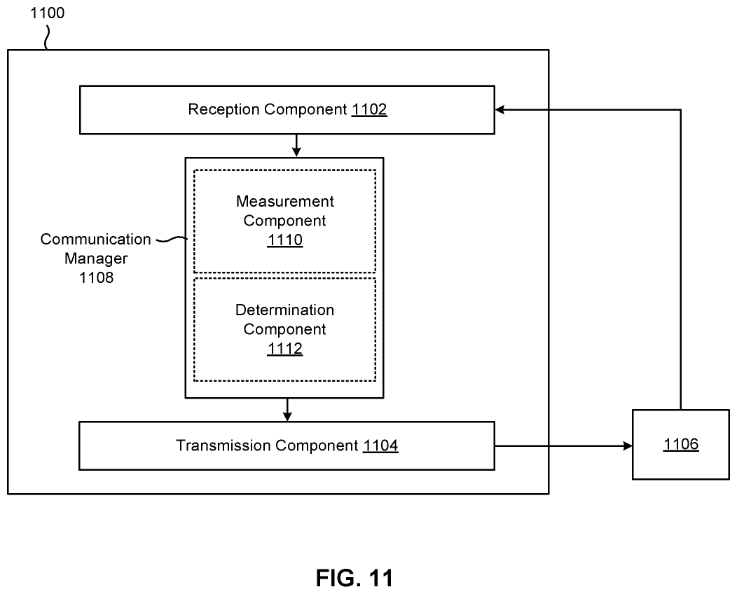

As shown in FIG. 9, in some aspects, process 900 may include receiving a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell (block 910). For example, the UE (e.g., using communication manager 1108 and/or reception component 1102, depicted in FIG. 11) may receive a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell, as described above.

As further shown in FIG. 9, in some aspects, process 900 may include measuring, in accordance with the radio link monitoring configuration, at least one of: one or more BFD-RSs of the first set of BFD-RSs, or one or more BFD-RSs of the second set of BFD-RSs (block 920). For example, the UE (e.g., using communication manager 1108 and/or measurement component 1110, depicted in FIG. 11) may measure, in accordance with the radio link monitoring configuration, at least one of: one or more BFD-RSs of the first set of BFD-RSs, or one or more BFD-RSs of the second set of BFD-RSs, as described above.

As further shown in FIG. 9, in some aspects, process 900 may include determining at least one of: a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs (block 930). For example, the UE (e.g., using communication manager 1108 and/or determination component 1112, depicted in FIG. 11) may determine at least one of: a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs, as described above.

Process 900 may include additional aspects, such as any single aspect or any combination of aspects described below and/or in connection with one or more other processes described elsewhere herein.

In a first aspect, process 900 includes receiving a configuration of a machine learning model, and determining, based at least in part on the machine learning model, the at least one of the beam failure associated with at least one of the first set of BFD-RSs or the first serving cell, or the beam failure associated with the at least one of the second set of BFD-RSs or the second serving cell.

In a second aspect, alone or in combination with the first aspect, an input to the machine learning model is based at least in part on at least one of an RSRP measurement associated with the one or more BFD-RSs of the second set of BFD-RSs, a PDCCH hypothesis BLER associated with the one or more BFD-RSs of the second set of BFD-RSs, a channel estimation associated with the one or more BFD-RSs of the second set of BFD-RSs, or a number of BFIs associated with the one or more BFD-RSs of the second set of BFD-RSs.

In a third aspect, alone or in combination with one or more of the first and second aspects, an input to the machine learning model is based at least in part on at least one of an RSRP measurement associated with the one or more BFD-RSs of the first set of BFD-RSs, a PDCCH hypothesis BLER associated with the one or more BFD-RSs of the first set of BFD-RSs, a channel estimation associated with the one or more BFD-RSs of the first set of BFD-RSs, or a number of BFIs associated with the one or more BFD-RSs of the first set of BFD-RSs.

In a fourth aspect, alone or in combination with one or more of the first through third aspects, at least one of the first set of BFD-RSs or the second set of BFD-RSs are associated with multi-port CSI-RS resources.

In a fifth aspect, alone or in combination with one or more of the first through fourth aspects, the measurement of the at least one of the one or more BFD-RSs of the first set of BFD-RSs or the one or more BFD-RSs of the second set of BFD-RSs includes performing measurements associated with each port of the multi-port CSI-RS resources.

In a sixth aspect, alone or in combination with one or more of the first through fifth aspects, the performance of measurements associated with each port of the multi-port CSI-RS resources includes at least one of performing an RSRP measurement associated with each port of the multi-port CSI-RS resources or estimating a channel associated with the multi-port CSI-RS resources.

In a seventh aspect, alone or in combination with one or more of the first through sixth aspects, process 900 includes receiving, via an RRC message, a configuration of the multi-port CSI-RS resources.

In an eighth aspect, alone or in combination with one or more of the first through seventh aspects, at least one of the first set of BFD-RSs or the second set of BFD-RSs is associated with one of AP-CSI-RS resources or SP-CSI-RS resources.

In a ninth aspect, alone or in combination with one or more of the first through eighth aspects, process 900 includes at least one of: based at least in part on receiving an activation message associated with the one of the AP-CSI-RS resources or the SP-CSI-RS resources, measuring the at least one of the first set of BFD-RSs or the second set of BFD-RSs: or prior to receiving the activation message, determining at least one of: the beam failure associated with the at least one of the first set of BFD-RS or the first serving cell based only on measuring one or more BFD-RSs of the first set of BFD-RSs, or the beam failure associated with the at least one of the second set of BFD-RS or the second serving cell based only on measuring one or more BFD-RSs of the second set of BFD-RSs.

In a tenth aspect, alone or in combination with one or more of the first through ninth aspects, process 900 includes receiving a reactivation message associated with the one of the AP-CSI-RS resources or the SP-CSI-RS resources, wherein the reactivation message indicates updated TCI states associated with the one of the AP-CSI-RS resources or the SP-CSI-RS resources, and determining, based at least in part on the updated TCI states, the at least one of the beam failure associated with the at least one of the first set of BFD-RSs or the first serving cell, or the beam failure associated with the at least one of the second set of BFD-RSs or the second serving cell.

In an eleventh aspect, alone or in combination with one or more of the first through tenth aspects, process 900 includes transmitting a request to activate the one of the AP-CSI-RS resources or the SP-CSI-RS resources.

In a twelfth aspect, alone or in combination with one or more of the first through eleventh aspects, the first set of BFD-RSs is associated with the one of the AP-CSI-RS resources or the SP-CSI-RS resources, and transmitting the request to activate the one of the AP-CSI-RS resources or the SP-CSI-RS resources is based at least in part on determining at least one of the beam failure associated with the at least one of the first set of BFD-RSs or the first serving cell, an RSRP associated with the one or more BFD-RSs of the second set BFD-RSs, or a PDCCH hypothesis BLER associated with the one or more BFD-RSs of the second set of BFD-RSs.

In a thirteenth aspect, alone or in combination with one or more of the first through twelfth aspects, the second set of BFD-RSs is associated with the one of the AP-CSI-RS resources or the SP-CSI-RS resources, and transmitting the request to activate the one of the AP-CSI-RS resources or the SP-CSI-RS resources is based at least in part on determining at least one of the beam failure associated with the at least one of the second set of BFD-RSs or the second serving cell, an RSRP associated with the one or more BFD-RSs of the first set BFD-RSs, or a PDCCH hypothesis BLER associated with the one or more BFD-RSs of the first set of BFD-RSs.

In a fourteenth aspect, alone or in combination with one or more of the first through thirteenth aspects, the request to activate the one of the AP-CSI-RS resources or the SP-CSI-RS resources is transmitted via one of a UCI message, a MAC-CE message, or an RRC message.

In a fifteenth aspect, alone or in combination with one or more of the first through fourteenth aspects, process 900 includes transmitting a request to deactivate the one of the AP-CSI-RS resources or the SP-CSI-RS resources.

In a sixteenth aspect, alone or in combination with one or more of the first through fifteenth aspects, the request to deactivate the one of the AP-CSI-RS resources or the SP-CSI-RS resources is transmitted via one of a UCI message, a MAC-CE message, or an RRC message.

In a seventeenth aspect, alone or in combination with one or more of the first through sixteenth aspects, the one of the AP-CSI-RS resources or the SP-CSI-RS resources is activated during a configured time period.

In an eighteenth aspect, alone or in combination with one or more of the first through seventeenth aspects, the UE is in wireless communication with a third serving cell, a BWP associated with an active BWP identifier in the second serving cell is a dormant BWP conditioned on a second frequency range associated with the second serving cell being higher than a third frequency range associated with the third serving cell and lower than a first frequency range associated with the first serving cell, and measuring the one or more BFD-RSs of the second set of BFD-RSs includes measuring the one or more BFD-RSs in the dormant BWP.

In a nineteenth aspect, alone or in combination with one or more of the first through eighteenth aspects, process 900 includes receiving a configuration indicating an updated second serving cell identifier.

In a twentieth aspect, alone or in combination with one or more of the first through nineteenth aspects, the configuration indicating the updated second serving cell identifier is received via one of a MAC-CE message or a DCI message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., base station 110, CU 310, DU 330, RU 340, or the like) performs operations associated with cross-frequency range predictive beam failure detection.

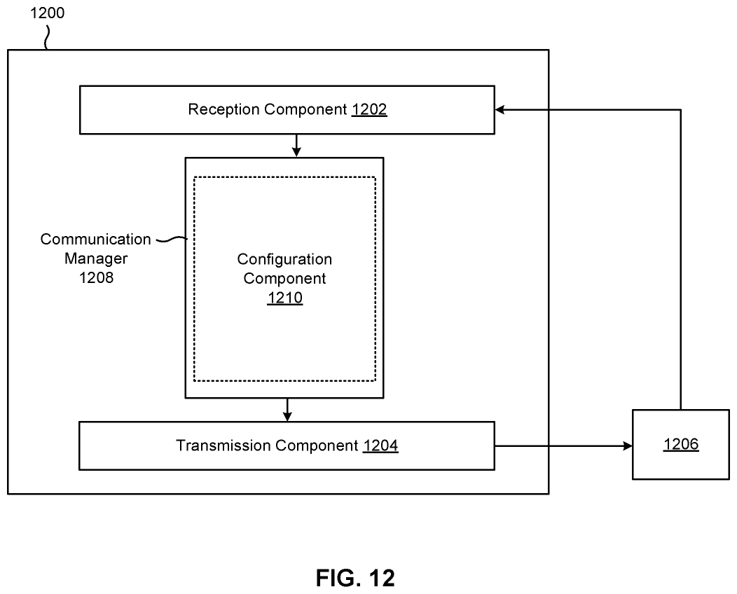

As shown in FIG. 10, in some aspects, process 1000 may include transmitting, to a UE, a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell (block 1010). For example, the network entity (e.g., using communication manager 1208, configuration component 1210, and/or transmission component 1204, depicted in FIG. 12) may transmit, to a UE, a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell, as described above.

As further shown in FIG. 10, in some aspects, process 1000 may include receiving, from the UE, a BFRQ, wherein the BFRQ is based at least in part on a determination of at least one of: a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs (block 1020). For example, the network entity (e.g., using communication manager 1208 and/or reception component 1202, depicted in FIG. 12) may receive, from the UE, a BFRQ, wherein the BFRQ is based at least in part on a determination of at least one of: a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs, as described above.

Process 1000 may include additional aspects, such as any single aspect or any combination of aspects described below and/or in connection with one or more other processes described elsewhere herein.

In a first aspect, process 1000 includes transmitting, to the UE, a configuration of a machine learning model, wherein the determination of the at least one of the beam failure associated with the at least one of the first set of BFD-RSs or the first serving cell or the beam failure associated with the at least one of the second set of BFD-RSs or the second serving cell is based at least in part on the machine learning model.

In a second aspect, alone or in combination with the first aspect, an input to the machine learning model is based at least in part on at least one of an RSRP measurement associated with the one or more BFD-RSs of the second set of BFD-RSs, a PDCCH hypothesis BLER associated with the one or more BFD-RSs of the second set of BFD-RSs, a channel estimation associated with the one or more BFD-RSs of the second set of BFD-RSs, or a number of BFIs associated with the one or more BFD-RSs of the second set of BFD-RSs.

In a third aspect, alone or in combination with one or more of the first and second aspects, an input to the machine learning model is based at least in part on at least one of an RSRP measurement associated with the one or more BFD-RSs of the first set of BFD-RSs, a PDCCH hypothesis BLER associated with the one or more BFD-RSs of the first set of BFD-RSs, a channel estimation associated with the one or more BFD-RSs of the first set of BFD-RSs, or a number of BFIs associated with the one or more BFD-RSs of the first set of BFD-RSs.

In a fourth aspect, alone or in combination with one or more of the first through third aspects, at least one of the first set of BFD-RSs or the second set of BFD-RSs are associated with multi-port CSI-RS resources.

In a fifth aspect, alone or in combination with one or more of the first through fourth aspects, the measurement of the at least one of the one or more BFD-RSs of the first set of BFD-RSs or the one or more BFD-RSs of the second set of BFD-RSs includes measurements associated with each port of the multi-port CSI-RS resources.

In a sixth aspect, alone or in combination with one or more of the first through fifth aspects, the measurements associated with each port of the multi-port CSI-RS resources include at least one of an RSRP measurement associated with each port of the multi-port CSI-RS resources or a channel estimation associated with the multi-port CSI-RS resources.

In a seventh aspect, alone or in combination with one or more of the first through sixth aspects, process 1000 includes transmitting, to the UE via an RRC message, a configuration of the multi-port CSI-RS resources.

In an eighth aspect, alone or in combination with one or more of the first through seventh aspects, at least one of the first set of BFD-RSs or the second set of BFD-RSs is associated with one of AP-CSI-RS resources or SP-CSI-RS resources.

In a ninth aspect, alone or in combination with one or more of the first through eighth aspects, process 1000 includes transmitting, to the UE, an activation message associated with the one of the AP-CSI-RS resources or the SP-CSI-RS resources.

In a tenth aspect, alone or in combination with one or more of the first through ninth aspects, process 1000 includes transmitting, to the UE, a reactivation message associated with the one of the AP-CSI-RS resources or the SP-CSI-RS resources, wherein the reactivation message indicates updated TCI states associated with the one of the AP-CSI-RS resources or the SP-CSI-RS resources.

In an eleventh aspect, alone or in combination with one or more of the first through tenth aspects, process 1000 includes receiving, from the UE, a request to activate the one of the AP-CSI-RS resources or the SP-CSI-RS resources.

In a twelfth aspect, alone or in combination with one or more of the first through eleventh aspects, the first set of BFD-RSs is associated with the one of the AP-CSI-RS resources or the SP-CSI-RS resources, and receiving the request to activate the one of the AP-CSI-RS resources or the SP-CSI-RS resources is based at least in part on determining at least one of the beam failure associated with the at least one of the first set of BFD-RSs or the first serving cell, an RSRP associated with the one or more BFD-RSs of the second set BFD-RSs, or a PDCCH hypothesis BLER associated with the one or more BFD-RSs of the second set of BFD-RSs.

In a thirteenth aspect, alone or in combination with one or more of the first through twelfth aspects, the second set of BFD-RSs is associated with the one of the AP-CSI-RS resources or the SP-CSI-RS resources, and receiving the request to activate the one of the AP-CSI-RS resources or the SP-CSI-RS resources is based at least in part on determining at least one of the beam failure associated with the at least one of the second set of BFD-RSs or the second serving cell, an RSRP associated with the one or more BFD-RSs of the first set BFD-RSs, or a PDCCH hypothesis BLER associated with the one or more BFD-RSs of the first set of BFD-RSs.

In a fourteenth aspect, alone or in combination with one or more of the first through thirteenth aspects, the request to activate the one of the AP-CSI-RS resources or the SP-CSI-RS resources is received via one of a UCI message, a MAC-CE message, or an RRC message.

In a fifteenth aspect, alone or in combination with one or more of the first through fourteenth aspects, process 1000 includes receiving a request to deactivate the one of the AP-CSI-RS resources or the SP-CSI-RS resources.

In a sixteenth aspect, alone or in combination with one or more of the first through fifteenth aspects, the request to deactivate the one of the AP-CSI-RS resources or the SP-CSI-RS resources is transmitted via one of a UCI message, a MAC-CE message, or an RRC message.

In a seventeenth aspect, alone or in combination with one or more of the first through sixteenth aspects, the one of the AP-CSI-RS resources or the SP-CSI-RS resources is activated during a configured time period.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., UE 120, UE 605, or the like), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108 (e.g., the communication manager 140). The communication manager 1108 may include one or more of a measurement component 1110, or a determination component 1112, among other examples.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The measurement component 1110 may measure, in accordance with the radio link monitoring configuration, at least one of one or more BFD-RSs of the first set of BFD-RSs, or one or more BFD-RSs of the second set of BFD-RSs. The determination component 1112 may determine at least one of a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

The reception component 1102 may receive a configuration of a machine learning model.

The determination component 1112 may determine, based at least in part on the machine learning model, the at least one of the beam failure associated with at least one of the first set of BFD-RSs or the first serving cell, or the beam failure associated with the at least one of the second set of BFD-RSs or the second serving cell.

The reception component 1102 may receive, via an RRC message, a configuration of the multi-port CSI-RS resources.

The reception component 1102 may receive a reactivation message associated with the one of the AP-CSI-RS resources or the SP-CSI-RS resources, wherein the reactivation message indicates updated TCI states associated with the one of the AP-CSI-RS resources or the SP-CSI-RS resources.

The determination component 1112 may determine, based at least in part on the updated TCI states, the at least one of the beam failure associated with the at least one of the first set of BFD-RSs or the first serving cell, or the beam failure associated with the at least one of the second set of BFD-RSs or the second serving cell.

The transmission component 1104 may transmit a request to activate the one of the AP-CSI-RS resources or the SP-CSI-RS resources.

The transmission component 1104 may transmit a request to deactivate the one of the AP-CSI-RS resources or the SP-CSI-RS resources.

The reception component 1102 may receive a configuration indicating an updated second serving cell identifier.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity (e.g., a base station 110, a CU 310, a DU 330, an RU 340, network entity 610, network entity 615, or the like), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208 (e.g., the communication manager 150). The communication manager 1208 may include a configuration component 1210, among other examples.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The transmission component 1204 and/or the configuration component 1210 may transmit, to a UE, a radio link monitoring configuration for a first serving cell, wherein the radio link monitoring configuration indicates a configuration of a first set of BFD-RSs associated with the first serving cell, a configuration of a second set of BFD-RSs associated with a second serving cell, and a second serving cell identifier of the second serving cell. The reception component 1202 may receive, from the UE, a BFRQ, wherein the BFRQ is based at least in part on a determination of at least one of a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

The transmission component 1204 and/or the configuration component 1210 may transmit, to the UE, a configuration of a machine learning model, wherein the determination of the at least one of the beam failure associated with the at least one of the first set of BFD-RSs or the first serving cell or the beam failure associated with the at least one of the second set of BFD-RSs or the second serving cell is based at least in part on the machine learning model.

The transmission component 1204 and/or the configuration component 1210 may transmit, to the UE via an RRC message, a configuration of the multi-port CSI-RS resources.

The transmission component 1204 may transmit, to the UE, an activation message associated with the one of the AP-CSI-RS resources or the SP-CSI-RS resources.

The transmission component 1204 may transmit, to the UE, a reactivation message associated with the one of the AP-CSI-RS resources or the SP-CSI-RS resources, wherein the reactivation message indicates updated TCI states associated with the one of the AP-CSI-RS resources or the SP-CSI-RS resources.

The reception component 1202 may receive, from the UE, a request to activate the one of the AP-CSI-RS resources or the SP-CSI-RS resources.

The reception component 1202 may receive a request to deactivate the one of the AP-CSI-RS resources or the SP-CSI-RS resources.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell: measuring, in accordance with the radio link monitoring configuration, at least one of: one or more BFD-RSs of the first set of BFD-RSs, or one or more BFD-RSs of the second set of BFD-RSs; and determining at least one of: a beam failure associated with at least one of the first set of BFD-RSs or the first serving cell based at least in part on measuring the one or more BFD-RSs of the second set of BFD-RSs, or a beam failure associated with at least one of the second set of BFD-RSs or the second serving cell based at least in part on measuring the one or more BFD-RSs of the first set of BFD-RSs.

Aspect 2: The method of Aspect 1, further comprising: receiving a configuration of a machine learning model; and determining, based at least in part on the machine learning model, the at least one of the beam failure associated with at least one of the first set of BFD-RSs or the first serving cell, or the beam failure associated with the at least one of the second set of BFD-RSs or the second serving cell.

Aspect 3: The method of Aspect 2, wherein an input to the machine learning model is based at least in part on at least one of an RSRP measurement associated with the one or more BFD-RSs of the second set of BFD-RSs, a PDCCH hypothesis BLER associated with the one or more BFD-RSs of the second set of BFD-RSs, a channel estimation associated with the one or more BFD-RSs of the second set of BFD-RSs, or a number of BFIs associated with the one or more BFD-RSs of the second set of BFD-RSs.

Aspect 4: The method of any of Aspects 2-3, wherein an input to the machine learning model is based at least in part on at least one of an RSRP measurement associated with the one or more BFD-RSs of the first set of BFD-RSs, a PDCCH hypothesis BLER associated with the one or more BFD-RSs of the first set of BFD-RSs, a channel estimation associated with the one or more BFD-RSs of the first set of BFD-RSs, or a number of BFIs associated with the one or more BFD-RSs of the first set of BFD-RSs.

Aspect 5: The method of any of Aspects 1-4, wherein at least one of the first set of BFD-RSs or the second set of BFD-RSs are associated with multi-port CSI-RS resources.

Aspect 6: The method of Aspect 5, wherein the measurement of the at least one of the one or more BFD-RSs of the first set of BFD-RSs or the one or more BFD-RSs of the second set of BFD-RSs includes performing measurements associated with each port of the multi-port CSI-RS resources.

Aspect 7: The method of Aspect 6, wherein the performance of measurements associated with each port of the multi-port CSI-RS resources includes at least one of performing an RSRP measurement associated with each port of the multi-port CSI-RS resources or estimating a channel associated with the multi-port CSI-RS resources.

Aspect 8: The method of any of Aspects 5-7, further comprising receiving, via an RRC message, a configuration of the multi-port CSI-RS resources.

Aspect 9: The method of any of Aspects 1-8, wherein at least one of the first set of BFD-RSs or the second set of BFD-RSs is associated with one of AP-CSI-RS resources or SP-CSI-RS resources.

Aspect 10: The method of Aspect 9, further comprising at least one of: based at least in part on receiving an activation message associated with the one of the AP-CSI-RS resources or the SP-CSI-RS resources, measuring the at least one of the first set of BFD-RSs or the second set of BFD-RSs, or, prior to receiving the activation message, determining at least one of: the beam failure associated with the at least one of the first set of BFD-RS or the first serving cell based only on measuring one or more BFD-RSs of the first set of BFD-RSs, or the beam failure associated with the at least one of the second set of BFD-RS or the second serving cell based only on measuring one or more BFD-RSs of the second set of BFD-RSs.

Aspect 11: The method of Aspect 10, further comprising: receiving a reactivation message associated with the one of the AP-CSI-RS resources or the SP-CSI-RS resources, wherein the reactivation message indicates updated TCI states associated with the one of the AP-CSI-RS resources or the SP-CSI-RS resources; and determining, based at least in part on the updated TCI states, the at least one of: the beam failure associated with the at least one of the first set of BFD-RSs or the first serving cell, or the beam failure associated with the at least one of the second set of BFD-RSs or the second serving cell.

Aspect 12: The method of any of Aspects 9-11, further comprising transmitting a request to activate the one of the AP-CSI-RS resources or the SP-CSI-RS resources.

Aspect 13: The method of Aspect 12, wherein the first set of BFD-RSs is associated with the one of the AP-CSI-RS resources or the SP-CSI-RS resources, and wherein transmitting the request to activate the one of the AP-CSI-RS resources or the SP-CSI-RS resources is based at least in part on determining at least one of: the beam failure associated with the at least one of the first set of BFD-RSs or the first serving cell, an RSRP associated with the one or more BFD-RSs of the second set BFD-RSs, or a PDCCH hypothesis BLER associated with the one or more BFD-RSs of the second set of BFD-RSs.

Aspect 14: The method of any of Aspects 12-13, wherein the second set of BFD-RSs is associated with the one of the AP-CSI-RS resources or the SP-CSI-RS resources, and wherein transmitting the request to activate the one of the AP-CSI-RS resources or the SP-CSI-RS resources is based at least in part on determining at least one of: the beam failure associated with the at least one of the second set of BFD-RSs or the second serving cell, an RSRP associated with the one or more BFD-RSs of the first set BFD-RSs, or a PDCCH hypothesis BLER associated with the one or more BFD-RSs of the first set of BFD-RSs.

Aspect 15: The method of any of Aspects 12-14, wherein the request to activate the one of the AP-CSI-RS resources or the SP-CSI-RS resources is transmitted via one of a UCI message, a MAC-CE message, or an RRC message.

Aspect 16: The method of any of Aspects 9-15, further comprising transmitting a request to deactivate the one of the AP-CSI-RS resources or the SP-CSI-RS resources.

Aspect 17: The method of Aspect 16, wherein the request to deactivate the one of the AP-CSI-RS resources or the SP-CSI-RS resources is transmitted via one of a UCI message, a MAC-CE message, or an RRC message.

Aspect 18: The method of any of Aspects 10-17, wherein the one of the AP-CSI-RS resources or the SP-CSI-RS resources is activated during a configured time period.

Aspect 19: The method of any of Aspects 1-18, wherein the UE is in wireless communication with a third serving cell, wherein a BWP associated with an active BWP identifier in the second serving cell is a dormant BWP conditioned on a second frequency range associated with the second serving cell being higher than a third frequency range associated with the third serving cell and lower than a first frequency range associated with the first serving cell, and wherein measuring the one or more BFD-RSs of the second set of BFD-RSs includes measuring the one or more BFD-RSs in the dormant BWP.

Aspect 20: The method of any of Aspects 1-19, further comprising receiving a configuration indicating an updated second serving cell identifier.

Aspect 21: The method of Aspect 20, wherein the configuration indicating the updated second serving cell identifier is received via one of a MAC-CE message or a DCI message.

Aspect 22: A method of wireless communication performed by a network entity, comprising: transmitting, to a UE, a radio link monitoring configuration for a first serving cell, wherein the radio link monitoring configuration indicates: a configuration of a first set of BFD-RSs associated with the first serving cell, a configuration of a second set of BFD-RSs associated with a second serving cell, and a second serving cell identifier of the second serving cell; and receiving, from the UE, a BFRQ, wherein the BFRQ is based at least in part on a determination of at least one of: a beam failure associated with at least one of the first set of BFD-RSs or the first serving cell based at least in part on a measurement of one or more BFD-RSs of the second set of BFD-RSs, or a beam failure associated with at least one of the second set of BFD-RSs or the second serving cell based at least in part on a measurement of one or more BFD-RSs of the first set of BFD-RSs.

Aspect 23: The method of Aspect 22, further comprising transmitting, to the UE, a configuration of a machine learning model, wherein the determination of the at least one of the beam failure associated with the at least one of the first set of BFD-RSs or the first serving cell or the beam failure associated with the at least one of the second set of BFD-RSs or the second serving cell is based at least in part on the machine learning model.

Aspect 24: The method of Aspect 23, wherein an input to the machine learning model is based at least in part on at least one of an RSRP measurement associated with the one or more BFD-RSs of the second set of BFD-RSs, a PDCCH hypothesis BLER associated with the one or more BFD-RSs of the second set of BFD-RSs, a channel estimation associated with the one or more BFD-RSs of the second set of BFD-RSs, or a number of BFIs associated with the one or more BFD-RSs of the second set of BFD-RSs.

Aspect 25: The method of any of Aspects 23-24, wherein an input to the machine learning model is based at least in part on at least one of an RSRP measurement associated with the one or more BFD-RSs of the first set of BFD-RSs, a PDCCH hypothesis BLER associated with the one or more BFD-RSs of the first set of BFD-RSs, a channel estimation associated with the one or more BFD-RSs of the first set of BFD-RSs, or a number of BFIs associated with the one or more BFD-RSs of the first set of BFD-RSs.

Aspect 26: The method of any of Aspects 22-25, wherein at least one of the first set of BFD-RSs or the second set of BFD-RSs are associated with multi-port CSI-RS resources.

Aspect 27: The method of Aspect 26, wherein the measurement of the at least one of the one or more BFD-RSs of the first set of BFD-RSs or the one or more BFD-RSs of the second set of BFD-RSs includes measurements associated with each port of the multi-port CSI-RS resources.

Aspect 28: The method of Aspect 27, wherein the measurements associated with each port of the multi-port CSI-RS resources include at least one of an RSRP measurement associated with each port of the multi-port CSI-RS resources or a channel estimation associated with the multi-port CSI-RS resources.

Aspect 29: The method of any of Aspects 26-28, further comprising transmitting, to the UE via an RRC message, a configuration of the multi-port CSI-RS resources.

Aspect 30: The method of any of Aspects 22-29, wherein at least one of the first set of BFD-RSs or the second set of BFD-RSs is associated with one of AP-CSI-RS resources or SP-CSI-RS resources.

Aspect 31: The method of Aspect 30, further comprising transmitting, to the UE, an activation message associated with the one of the AP-CSI-RS resources or the SP-CSI-RS resources.

Aspect 32: The method of Aspect 31, further comprising transmitting, to the UE, a reactivation message associated with the one of the AP-CSI-RS resources or the SP-CSI-RS resources, wherein the reactivation message indicates updated TCI states associated with the one of the AP-CSI-RS resources or the SP-CSI-RS resources.

Aspect 33: The method of any of Aspects 30-32, further comprising receiving, from the UE, a request to activate the one of the AP-CSI-RS resources or the SP-CSI-RS resources.

Aspect 34: The method of Aspect 33, wherein the first set of BFD-RSs is associated with the one of the AP-CSI-RS resources or the SP-CSI-RS resources, and wherein receiving the request to activate the one of the AP-CSI-RS resources or the SP-CSI-RS resources is based at least in part on determining at least one of: the beam failure associated with the at least one of the first set of BFD-RSs or the first serving cell, an RSRP associated with the one or more BFD-RSs of the second set BFD-RSs, or a PDCCH hypothesis BLER associated with the one or more BFD-RSs of the second set of BFD-RSs.

Aspect 35: The method of any of Aspects 33-34, wherein the second set of BFD-RSs is associated with the one of the AP-CSI-RS resources or the SP-CSI-RS resources, and wherein receiving the request to activate the one of the AP-CSI-RS resources or the SP-CSI-RS resources is based at least in part on determining at least one of: the beam failure associated with the at least one of the second set of BFD-RSs or the second serving cell, an RSRP associated with the one or more BFD-RSs of the first set BFD-RSs, or a PDCCH hypothesis BLER associated with the one or more BFD-RSs of the first set of BFD-RSs.

Aspect 36: The method of any of Aspects 33-35, wherein the request to activate the one of the AP-CSI-RS resources or the SP-CSI-RS resources is received via one of a UCI message, a MAC-CE message, or an RRC message.

Aspect 37: The method of any of Aspects 30-36, further comprising receiving a request to deactivate the one of the AP-CSI-RS resources or the SP-CSI-RS resources.

Aspect 38: The method of Aspect 37, wherein the request to deactivate the one of the AP-CSI-RS resources or the SP-CSI-RS resources is transmitted via one of a UCI message, a MAC-CE message, or an RRC message.

Aspect 39: The method of any of Aspects 31-38, wherein the one of the AP-CSI-RS resources or the SP-CSI-RS resources is activated during a configured time period.

Aspect 40: An apparatus for wireless communication at a device, comprising a processor: memory coupled with the processor; and instructions stored in the memory and executable by the processor to cause the apparatus to perform the method of one or more of Aspects 1-21.

Aspect 41: A device for wireless communication, comprising a memory and one or more processors coupled to the memory, the one or more processors configured to perform the method of one or more of Aspects 1-21.

Aspect 42: An apparatus for wireless communication, comprising at least one means for performing the method of one or more of Aspects 1-21.

Aspect 43: A non-transitory computer-readable medium storing code for wireless communication, the code comprising instructions executable by a processor to perform the method of one or more of Aspects 1-21.

Aspect 44: A non-transitory computer-readable medium storing a set of instructions for wireless communication, the set of instructions comprising one or more instructions that, when executed by one or more processors of a device, cause the device to perform the method of one or more of Aspects 1-21.

Aspect 45: An apparatus for wireless communication at a device, comprising a processor: memory coupled with the processor; and instructions stored in the memory and executable by the processor to cause the apparatus to perform the method of one or more of Aspects 22-39.

Aspect 46: A device for wireless communication, comprising a memory and one or more processors coupled to the memory, the one or more processors configured to perform the method of one or more of Aspects 22-39.

Aspect 47: An apparatus for wireless communication, comprising at least one means for performing the method of one or more of Aspects 22-39.

Aspect 48: A non-transitory computer-readable medium storing code for wireless communication, the code comprising instructions executable by a processor to perform the method of one or more of Aspects 22-39.

Aspect 45: A non-transitory computer-readable medium storing a set of instructions for wireless communication, the set of instructions comprising one or more instructions that, when executed by one or more processors of a device, cause the device to perform the method of one or more of Aspects 22-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a radio link monitoring configuration for a first serving cell, wherein the radio link monitoring configuration indicates:
a configuration of a first set of beam-failure-detection reference signals (BFD-RSs) associated with the first serving cell,
a configuration of a second set of BFD-RSs associated with a second serving cell, and
a second serving cell identifier of the second serving cell:
measure, in accordance with the radio link monitoring configuration, at least one of:
one or more BFD-RSs of the first set of BFD-RSs, or
one or more BFD-RSs of the second set of BFD-RSs; and
determine at least one of:
a beam failure associated with at least one of the first set of BFD-RSs or the first serving cell based at least in part on measuring the one or more BFD-RSs of the second set of BFD-RSs, or
a beam failure associated with at least one of the second set of BFD-RSs or the second serving cell based at least in part on measuring the one or more BFD-RSs of the first set of BFD-RSs.

2. The apparatus of claim 1, wherein the one or more processors are further configured to:
receive a configuration of a machine learning model; and
determine, based at least in part on the machine learning model, the at least one of the beam failure associated with at least one of the first set of BFD-RSs or the first serving cell, or the beam failure associated with the at least one of the second set of BFD-RSs or the second serving cell.

3. The apparatus of claim 2, wherein an input to the machine learning model is based at least in part on at least one of a reference signal received power (RSRP) measurement associated with the one or more BFD-RSs of the second set of BFD-RSs, a physical downlink control channel (PDCCH) hypothesis block error rate (BLER) associated with the one or more BFD-RSs of the second set of BFD-RSs, a channel estimation associated with the one or more BFD-RSs of the second set of BFD-RSs, or a number of beam failure instances (BFIs) associated with the one or more BFD-RSs of the second set of BFD-RSs.

4. The apparatus of claim 2, wherein an input to the machine learning model is based at least in part on at least one of a reference signal received power (RSRP) measurement associated with the one or more BFD-RSs of the first set of BFD-RSs, a physical downlink control channel (PDCCH) hypothesis block error rate (BLER) associated with the one or more BFD-RSs of the first set of BFD-RSs, a channel estimation associated with the one or more BFD-RSs of the first set of BFD-RSs, or a number of beam failure instances (BFIs) associated with the one or more BFD-RSs of the first set of BFD-RSs.

5. The apparatus of claim 1, wherein at least one of the first set of BFD-RSs or the second set of BFD-RSs are associated with multi-port channel state information reference signal (CSI-RS) resources.

6. The apparatus of claim 5, wherein the measurement of the at least one of the one or more BFD-RSs of the first set of BFD-RSs or the one or more BFD-RSs of the second set of BFD-RSs includes performing measurements associated with each port of the multi-port CSI-RS resources.

7. The apparatus of claim 6, wherein the performance of measurements associated with each port of the multi-port CSI-RS resources includes at least one of performing a reference signal received power (RSRP) measurement associated with each port of the multi-port CSI-RS resources or estimating a channel associated with the multi-port CSI-RS resources.

8. The apparatus of claim 5, wherein the one or more processors are further configured to receive, via a radio resource control (RRC) message, a configuration of the multi-port CSI-RS resources.

9. The apparatus of claim 1, wherein at least one of the first set of BFD-RSs or the second set of BFD-RSs is associated with one of aperiodic channel state information reference signal (AP-CSI-RS) resources or semipersistent channel state information reference signal (SP-CSI-RS) resources.

10. The apparatus of claim 9, wherein the one or more processors are further configured to at least one of:
based at least in part on receiving an activation message associated with the one of the AP-CSI-RS resources or the SP-CSI-RS resources, measuring the at least one of the first set of BFD-RSs or the second set of BFD-RSs, or
prior to receiving the activation message, determining at least one of:
the beam failure associated with the at least one of the first set of BFD-RS or the first serving cell based only on measuring one or more BFD-RSs of the first set of BFD-RSs, or
the beam failure associated with the at least one of the second set of BFD-RS or the second serving cell based only on measuring one or more BFD-RSs of the second set of BFD-RSs.

11. The apparatus of claim 10, wherein the one or more processors are further configured to:
receive a reactivation message associated with the one of the AP-CSI-RS resources or the SP-CSI-RS resources, wherein the reactivation message indicates updated transmission configuration indicator (TCI) states associated with the one of the AP-CSI-RS resources or the SP-CSI-RS resources; and
determine, based at least in part on the updated TCI states, the at least one of:
the beam failure associated with the at least one of the first set of BFD-RSs or the first serving cell, or
the beam failure associated with the at least one of the second set of BFD-RSs or the second serving cell.

12. The apparatus of claim 9, wherein the one or more processors are further configured to transmit a request to activate the one of the AP-CSI-RS resources or the SP-CSI-RS resources.

13. The apparatus of claim 12, wherein the first set of BFD-RSs is associated with the one of the AP-CSI-RS resources or the SP-CSI-RS resources, and wherein transmitting the request to activate the one of the AP-CSI-RS resources or the SP-CSI-RS resources is based at least in part on determining at least one of:
the beam failure associated with the at least one of the first set of BFD-RSs or the first serving cell,
a reference signal received power (RSRP) associated with the one or more BFD-RSs of the second set BFD-RSs, or
a physical downlink control channel (PDCCH) hypothesis block error rate (BLER) associated with the one or more BFD-RSs of the second set of BFD-RSs.

14. The apparatus of claim 12, wherein the second set of BFD-RSs is associated with the one of the AP-CSI-RS resources or the SP-CSI-RS resources, and wherein transmitting the request to activate the one of the AP-CSI-RS resources or the SP-CSI-RS resources is based at least in part on determining at least one of:
the beam failure associated with the at least one of the second set of BFD-RSs or the second serving cell,
a reference signal received power (RSRP) associated with the one or more BFD-RSs of the first set BFD-RSs, or
a physical downlink control channel (PDCCH) hypothesis block error rate (BLER) associated with the one or more BFD-RSs of the first set of BFD-RSs.

15. The apparatus of claim 12, wherein the request to activate the one of the AP-CSI-RS resources or the SP-CSI-RS resources is transmitted via one of an uplink control information (UCI) message, a medium access control (MAC) control element (MAC-CE) message, or a radio resource control (RRC) message.

16. The apparatus of claim 9, wherein the one or more processors are further configured to transmit a request to deactivate the one of the AP-CSI-RS resources or the SP-CSI-RS resources.

17. The apparatus of claim 16, wherein the request to deactivate the one of the AP-CSI-RS resources or the SP-CSI-RS resources is transmitted via one of an uplink control information (UCI) message, a medium access control (MAC) control element (MAC-CE) message, or a radio resource control (RRC) message.

18. The apparatus of claim 10, wherein the one of the AP-CSI-RS resources or the SP-CSI-RS resources is activated during a configured time period.

19. The apparatus of claim 1, wherein the UE is in wireless communication with a third serving cell, wherein a bandwidth part (BWP) associated with an active BWP identifier in the second serving cell is a dormant BWP conditioned on a second frequency range associated with the second serving cell being higher than a third frequency range associated with the third serving cell and lower than a first frequency range associated with the first serving cell, and wherein measuring the one or more BFD-RSs of the second set of BFD-RSs includes measuring the one or more BFD-RSs in the dormant BWP.

20. The apparatus of claim 1, wherein the one or more processors are further configured to receive a configuration indicating an updated second serving cell identifier.

21. The apparatus of claim 20, wherein the configuration indicating the updated second serving cell identifier is received via one of a medium access control (MAC) control element (MAC-CE) message or a downlink control information (DCI) message.

22. An apparatus for wireless communication at a network entity, comprising:
a memory; and
one or more processors, coupled to the memory, configured to:
transmit, to a user equipment (UE), a radio link monitoring configuration for a first serving cell, wherein the radio link monitoring configuration indicates:
a configuration of a first set of beam-failure-detection reference signals (BFD-RSs) associated with the first serving cell,
a configuration of a second set of BFD-RSs associated with a second serving cell, and
a second serving cell identifier of the second serving cell; and
receive, from the UE, a beam failure recovery request (BFRQ), wherein the BFRQ is based at least in part on a determination of at least one of:
a beam failure associated with at least one of the first set of BFD-RSs or the first serving cell based at least in part on a measurement of one or more BFD-RSs of the second set of BFD-RSs, or
a beam failure associated with at least one of the second set of BFD-RSs or the second serving cell based at least in part on a measurement of one or more BFD-RSs of the first set of BFD-RSs.

23. The apparatus of claim 22, wherein the one or more processors are further configured to transmit, to the UE, a configuration of a machine learning model, wherein the determination of the at least one of the beam failure associated with the at least one of the first set of BFD-RSs or the first serving cell or the beam failure associated with the at least one of the second set of BFD-RSs or the second serving cell is based at least in part on the machine learning model.

24. The apparatus of claim 22, wherein at least one of the first set of BFD-RSs or the second set of BFD-RSs are associated with multi-port channel state information reference signal (CSI-RS) resources.

25. The apparatus of claim 22, wherein at least one of the first set of BFD-RSs or the second set of BFD-RSs is associated with one of aperiodic channel state information reference signal (AP-CSI-RS) resources or semipersistent channel state information reference signal (SP-CSI-RS) resources.

26. The network entity of claim 25, wherein the one or more processors are further configured to receive, from the UE, a request to activate the one of the AP-CSI-RS resources or the SP-CSI-RS resources.

27. A method of wireless communication performed by a user equipment (UE), comprising:
receiving a radio link monitoring configuration for a first serving cell, wherein the radio link monitoring configuration indicates:
a configuration of a first set of beam-failure-detection reference signals (BFD-RSs) associated with the first serving cell,
a configuration of a second set of BFD-RSs associated with a second serving cell, and
a second serving cell identifier of the second serving cell:
measuring, in accordance with the radio link monitoring configuration, at least one of:
one or more BFD-RSs of the first set of BFD-RSs, or
one or more BFD-RSs of the second set of BFD-RSs; and
determining at least one of:
a beam failure associated with at least one of the first set of BFD-RSs or the first serving cell based at least in part on measuring the one or more BFD-RSs of the second set of BFD-RSs, or
a beam failure associated with at least one of the second set of BFD-RSs or the second serving cell based at least in part on measuring the one or more BFD-RSs of the first set of BFD-RSs.

28. The method of claim 27, further comprising:
receiving a configuration of a machine learning model; and
determining, based at least in part on the machine learning model, the at least one of the beam failure associated with at least one of the first set of BFD-RSs or the first serving cell, or the beam failure associated with the at least one of the second set of BFD-RSs or the second serving cell.

29. A method of wireless communication performed by a network entity, comprising:
transmitting, to a user equipment (UE), a radio link monitoring configuration for a first serving cell, wherein the radio link monitoring configuration indicates:
a configuration of a first set of beam-failure-detection reference signals (BFD-RSs) associated with the first serving cell,
a configuration of a second set of BFD-RSs associated with a second serving cell, and
a second serving cell identifier of the second serving cell; and
receiving, from the UE, a beam failure recovery request (BFRQ), wherein the BFRQ is based at least in part on a determination of at least one of:
a beam failure associated with at least one of the first set of BFD-RSs or the first serving cell based at least in part on a measurement of one or more BFD-RSs of the second set of BFD-RSs, or
a beam failure associated with at least one of the second set of BFD-RSs or the second serving cell based at least in part on a measurement of one or more BFD-RSs of the first set of BFD-RSs.

30. The method of claim 29, further comprising transmitting, to the UE, a configuration of a machine learning model, wherein the determination of the at least one of the beam failure associated with the at least one of the first set of BFD-RSs or the first serving cell or the beam failure associated with the at least one of the second set of BFD-RSs or the second serving cell is based at least in part on the machine learning model.
